(19) United States
(12) Patent Application Publication
(10) Pub. No.: US 2009/0321329 A1
(43) Pub. Date: Dec. 31, 2009

(54) EXPANSION TANK PROVIDED WITH A FLOAT

(76) Inventors: Cristijn Melchior De Vin, Aldeboarn (NL); Johannes Cornelis Hakker, Uytenbosch (NL)

Correspondence Address: LAW OFFICES OF ERIC KARICH, 2807 ST. MARK DR., MANSFIELD, TX, 76063, US

(21) Appl. No.: 12/428,593

(22) Filed: Apr. 23, 2009

(30) Foreign Application Priority Data
Oct. 25, 2006 (NL) PCT/NL2007/050507

(51) Int. Cl. B01D 29/60

(52) U.S. Cl. 210/123

(57) ABSTRACT

An expansion tank has a vertically set up cylinder with a float therein, which forms a separating element between water and gas in the cylinder. The float is present in the cylinder with play and is provided with sealing rings over the circumference, which are in contact with the cylinder wall. An opening at the bottom of the cylinder is adapted to be connected with a pipe. A raised edge around the opening is adapted to form a sealing engagement with the float.

### BACKGROUND OF THE INVENTION

1. Field of the Invention

The invention relates to an expansion tank comprising a cylinder, which is closed at the top and bottom, and contains therein a separating element for separating liquid and gas in the cylinder, which separating element is formed by a float, and which cylinder is provided with an opening on or near the bottom to which a pipe can be connected for the supply and removal of liquid.

An expansion tank is often used as a buffer in a water treatment system in order to supply any water required in the system. The gas pressure in the cylinder ensures that the water is pressed out of the cylinder if the pressure in the pipe drops below the gas pressure. The separating element serves to prevent the gas from reacting with constituents in the water.

2. Prior art

A similar expansion tank is illustrated in EP-A-1 484 557. In this expansion tank, the opening is near the bottom in the side wall of the cylinder. The float can close the opening if all liquid has flowed out of the cylinder and the float is at the bottom of the cylinder. The presence of the opening in the side wall makes it relatively difficult for the float to seal the opening efficiently.

### SUMMARY OF THE INVENTION

An objective of the invention is to improve the known expansion tank. For this purpose, the expansion tank according to the invention is characterised in that the opening is at the bottom of the cylinder and there is a raised edge on the inside of the cylinder, around the opening. The space above the bottom of the cylinder up to the top of the raised edge thus forms a space where unforeseen precipitation can be collected. This means that the float always seals off the opening efficiently when in the lowest position.

A further embodiment of the expansion tank according to the invention is characterised in that the float is provided with a further seal on the bottom, which, if the float is at the bottom of the cylinder, is in contact with the raised edge around the opening. The float will drop to the bottom of the cylinder if more water is required in the system than the pump can supply, so that this further seal closes the opening so that no air/gas can enter the water treatment system.

There is preferably some play between the float and the side wall of the cylinder, so that the float can be moved in the cylinder without friction. The play is preferably small in order to prevent the gas from coming into contact with the liquid over a large area.

Moreover, the circumference of the float is preferably provided with sealing devices, which are in contact with the cylinder wall. This means the gas on the whole cannot come into contact with the liquid. The sealing devices are preferably not clamping or are only in contact with the cylinder wall with a low clamping pressure so that the float can move in the cylinder fully or virtually fully free of friction.

A still further embodiment of the expansion tank according to the invention is characterised in that the expansion tank is provided with connections on or near the bottom and the top via which the expansion tank can be connected to a further expansion tank, so that the spaces above and below the float are brought into connection with the corresponding spaces in the cylinder of the further expansion tank. A simple volume increase can be achieved in this way.

### BRIEF DESCRIPTION OF THE DRAWINGS

The invention will be elucidated more fully below on the basis of drawings in which an embodiment of the expansion tank according to the invention is shown. In these drawings:

FIG. 1 shows a part of a water treatment system provided with an expansion tank according to the invention; and

FIG. 2 shows the expansion tank of the system shown in FIG. 1 in longitudinal cross-section.

### DETAILED DESCRIPTION OF THE DRAWINGS

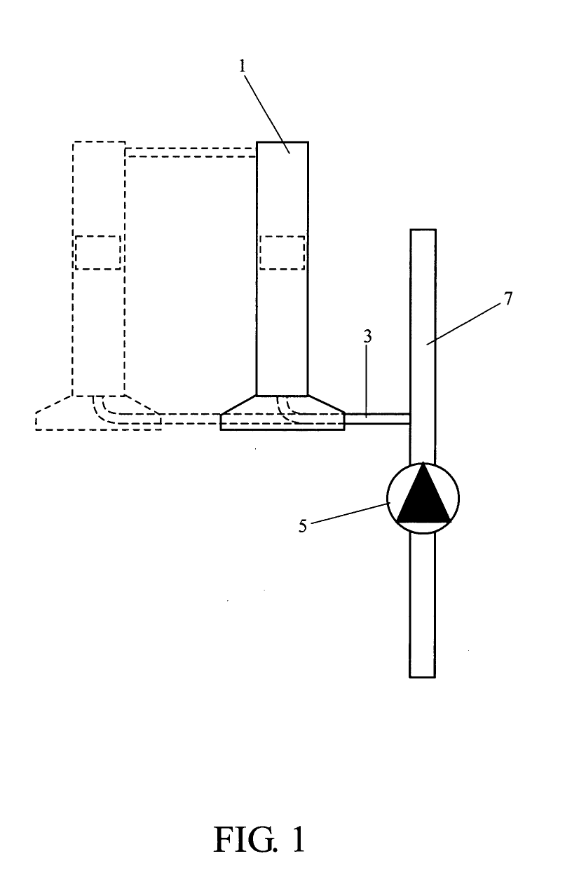

FIG. 1 shows a part of a water treatment system that comprises an expansion tank 1 with a pipe 3 connected to it, which is connected to a pump 5 that is connected to a water supply pipe 7 to the rest of the system. If water is consumed in the system, the water level in the expansion tank 1 will drop until the pressure in the expansion tank drops below a prior set minimum value and the pump 5 will begin to operate and pump water into the expansion tank until the pressure in the expansion tank has risen to the maximum operating pressure of the pump.

If more water is required in the system than the pump 5 can supply, the float will drop to the bottom of the cylinder until it closes the opening. This means that no air/gas can enter the water treatment system.

Volume increase can be achieved in this system by connecting two or more expansion tanks both above and below. This is indicated by dotted lines.

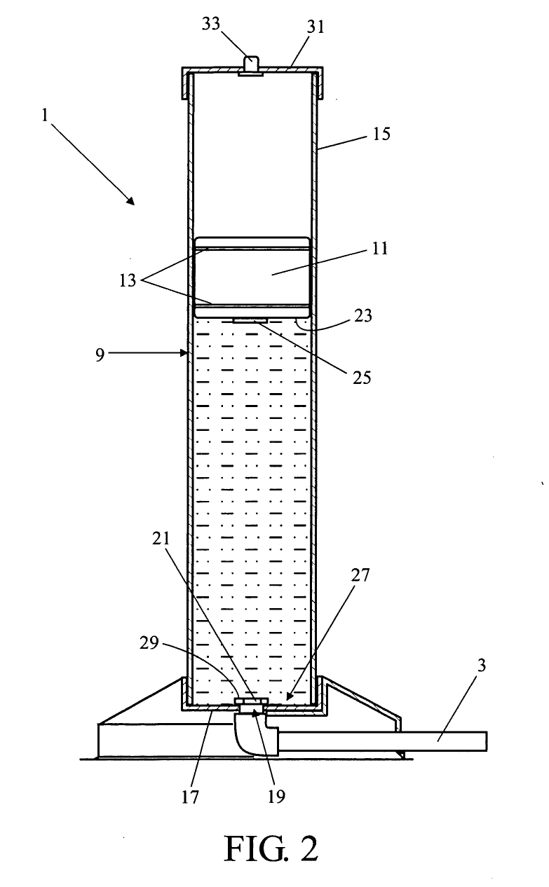

FIG. 2 shows the expansion tank 1 of the system shown in FIG. 1 in longitudinal cross-section. The expansion tank 1 has a vertically set-up cylinder 9, closed at the top and bottom, with a float 11 therein, which forms a separating element for separating water 13 and gas 15 in the cylinder. The inert gas nitrogen can be used for example. The float 11 has a lower specific gravity than water and is present in the cylinder with play. The float 11 is provided with sealing rings over the circumference 13, which are in contact with the cylinder wall 15.

There is an opening 19 at the bottom 17 of the cylinder 9 to which the pipe 3 is connected. There is a raised edge 21 around the opening 19, which forms a valve seat. The float 11 is provided with a further seal 25 on the bottom 23, which is formed by a rubber disc, which, if the float is at the bottom of cylinder, is in contact with the raised edge 21 around the opening and closes the opening. The space 27 above the bottom 17 of the cylinder up to the top 29 of the raised edge 21 thus forms a space to collect unforeseen precipitation.

There is a valve 33 at the top 31 of the cylinder 9 to pre-pressurise the gas in the cylinder.

Although in the above the invention is explained on the basis of the drawings, it should be noted that the invention is in no way limited to the embodiment shown in the drawings. The invention also extends to all embodiments deviating from the embodiment shown in the drawings within the context defined by the claims. The cylinder can thus also be set up horizontally or in any other orientation. If the cylinder is set up vertically or mainly vertically, a float with no sealing rings 13 can also be used. The expansion tank according to the invention can also be used in a central heating installation to deal with the expansion of the water on heating.

What is claimed is:

1. An expansion tank for attachment to a pipe, the expansion tank comprising:
a cylinder, which is closed at a top a bottom, and contains therein a separating element for separating liquid and gas in the cylinder, which separating element is formed by a float;
an opening through the bottom adapted to engage the pipe such that the cylinder can be connected for the supply and removal of liquid; and
a raised edge on an inside of the cylinder, around the opening.

2. The expansion tank according to claim 1, further comprising a seal on a bottom of the float, which, if the float is at the bottom of the cylinder, is in contact with the raised edge around the opening.

3. The expansion tank according to claim 1, characterised in that there is play between the float and a side wall of the cylinder.

4. The expansion tank according to claim 1, characterised in that the float is provided with sealing devices on a circumference, which are in contact with the cylinder wall.

5. The expansion tank according to claim 1, characterised in that the expansion tank is provided with connections on or near the bottom and the top via which the expansion tank can be connected to a further expansion tank, so that spaces below and above the float are brought into connection with corresponding spaces in the cylinder of the further expansion tank.
